(19) United States
(12) Patent Application Publication
(10) Pub. No.: US 2007/0005270 A1
(43) Pub. Date: Jan. 4, 2007

(54) Method for examining plate steel on concrete

(75) Inventors: Chung-Yue Wang, Jhongli City (TW); Peng-Ching Peng, Zhonghe City (TW)

Correspondence Address: TROXELL LAW OFFICE PLLC;SUITE 1404, 5205 LEESBURG PIKE, FALLS CHURCH, VA, 22041, US

(73) Assignee: National Central University

(21) Appl. No.: 11/165,378

(22) Filed: Jun. 24, 2005

(51) Int. Cl. G06F 19/00

(52) U.S. Cl. 702/39

(57) ABSTRACT

The present invention examines coherence integrity of a joint interface between a construction and a reinforcing plate steel in a to-be-examined area by comparing a waveform obtained in advance with a back echo waveform received.

### BACKGROUND OF THE INVENTION

1. Field of Invention

The present invention relates to a method for examining steel; more particularly, relates to identifying coherence integrity of a joint interface between a construction and a reinforcing plate steel.

2. Related Prior Art

Owing to different climate environments and natural disasters (like earthquakes, typhoons, etc.), constructions are under threats to become inferior with some damages. For the constructions to effectively stand against the next disaster that might happen, except dismantling ruined buildings to be rebuilt, reinforcing other buildings having less damages is the most economic and effective way. A structural patch used in a reinforcing engineering appeared as early as in the 1960s which utilized a plate steel and an epoxy resin in a reinforcement work. Because of easy constituting, fast recovering on the toughness of the construction, and less deforming over the cross-section of the construction, reinforcing by using plate steels is one of the most widely applied method. The reinforcement is done by wrapping the plate steel to be covered on a surface of a damaged construction while filling with the epoxy resin to reinforce the coherence. The functionality of the epoxy resin on cohering the plate steel and the construction will affect the execution and the effectiveness of the whole reinforcement work. However, because the epoxy resin is wrapped with the plate steel at the outside, until now, it is still impossible to effectively determine the quality of the coherence in a visual way or with a non-destructive examination. Hence, difficulties happen with on-site constructing and checking.

One of the method for reinforcing an RC (reinforced concrete) construction is done by applying plate steels, which reinforce the weak part of the RC construction, such as the moment, the shear, the torsion or the durability, etc. But, for the success of the reinforcement work, the interfaces between the plate steel, the coherence layer and the concrete have to be strengthened at first to provide a base for designing or analyzing.

Prior arts concerning utilizing a plate steel on reinforcing an RC construction are as follows: In Wen-shan Lin, “Study on RC Structures Strengthened by External Steel Plates”, Doctorial Dissertation of NTU, Taiwan, 2001, an experimental device is designed with considerations on the temperature, the surface treatment of the plate steel and the concrete, the thickness of the coherence layer, etc. to show the failure criteria (Mohr-Culomb failure law) under the tension with shear. A nonlinear finite element program is also developed to simulate the response of an RC structure strengthened by plate steels. In K. Vine et al., “Comparison of Normal and Oblique Incidence Ultrasonic Measurements for the Detection of Environment Degradation of Adhesive Joint”, NDT & E, 2002, damages by the environment on an adhesive joint of a material of aluminum by a normal and oblique incidence is studied. In S. Legendre et al., “Ultrasonic NDE of Composite Material Structures Using Wavelet Coefficient”, NDT & E, 2002, a spectrum analysis over wavelet signals is studied to obtain a wavelet coefficient module for a mathematical analysis by using a non-destructive analysis toward a composite material used for a low-temperature container. In D. McNab et al., “An intelligent approach to inspection qualification”, NDT & E, 2005, an approach to inspection qualification is discussed concerning the process flow and the linkage path of the examination database; and, a possible steps for building an evaluation standard is also introduced.

Reinforcement work has become a key issue for keeping the safety of a construction after damages; and, the reinforcement by utilizing plate steels is the most frequently used now. Yet, even though examining coherence integrity between a reinforcement and a matrix is the base for checking and appraising construction, no method for solving the problem of checking and appraising construction is found in the prior arts.

### SUMMARY OF INVENTION

Therefore, the main purpose of the present invention is, by using an ultrasonic detector, to compare a comparative waveform obtained in advance with a back echo waveform received, so that coherence integrity of a joint interface between a plate steel and a concrete is identified in a to-be-examined area.

To achieve the above purpose, the present invention is a method for examining a plate steel on a concrete, comprising steps of: obtaining a comparative waveform; obtaining an ultrasonic detector with the comparative waveform inputted in; marking off a to-be-examined area on a surface of the plate steel; in the to-be-examined area, obtaining a benchmark for an examination; transmitting signals from the ultrasonic detector to the benchmark; receiving a back echo waveform at the benchmark by the ultrasonic detector; and, by using the ultrasonic detector, comparing the comparative waveform with the back echo waveform to identify coherence integrity of the joint interface between the plate steel and the concrete in the to-be-examined area. Accordingly, a method for examining a plate steel on a concrete is obtained.

### BRIEF DESCRIPTION OF DRAWINGS

The present invention will be better understood from the following detailed descriptions of the preferred embodiments according to the present invention, taken in conjunction with the accompanying drawings, in which

FIG. 1 is a view of an ultrasonic detector according to the present invention;

FIG. 2 is a flow chart of the method for examining a plate steel on a concrete according to the present invention; and

FIG. 3 is a view of a state of use according to the present invention.

### DETAILED DESCRIPTION OF PREFERRED EMBODIMENTS

The following descriptions of the preferred embodiments are provided to understand the features and the structures of the present invention.

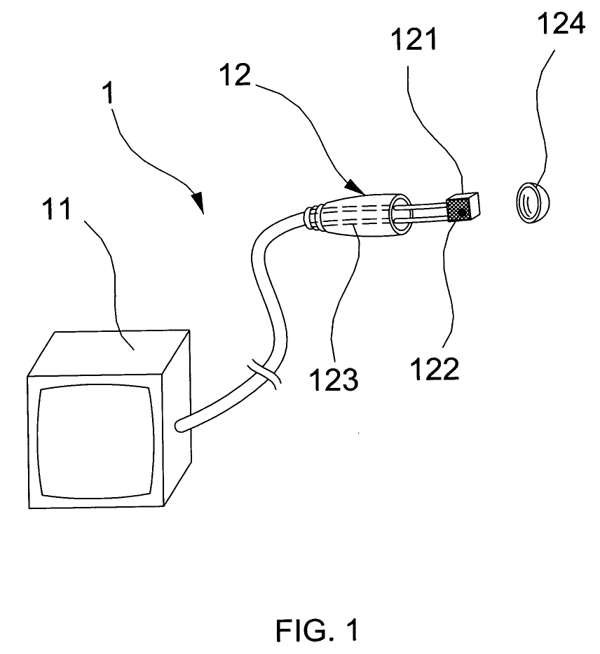

Please refer to FIG. 1, which is a view of an ultrasonic detector according to the present invention. As shown in the figure, the present invention is a method for examining a plate steel on a concrete by comparing a previously obtained comparative waveform with a detected back echo waveform to respectively identify coherence integrity of a joint interface between the plate steel and the concrete in each to-be-examined area.

The ultrasonic detector 1 comprises an ultrasonic examining unit 11 and a probing unit 12 connected with the ultrasonic examining unit 11. The frequency of signals from the ultrasonic detector is located between 1 MHz and 25 MHz with a preferred range between 1 MHz and 5 MHz. The probing unit 12 further comprises a piezocrystal 121, a back filler 122, a leading wire 123 and a wear-resisting layer 124. Therein, the piezocrystal 121 obtains a piezoelectric characteristic after a process of polarization. The piezocrystal 121 is plated with the back filler 122 of a metal membrane, made of a metal powder (such as silver, aluminum, etc.) mixed with a glue, on two opposite surfaces to spread a voltage on the surfaces by connected with the leading wire 123; and to obtain a distinguishability of a pulse wave from the piezocrystal 121 by absorbing a proper power from the ultrasonics. The front tip of the piezocrystal 121 is pasted with the wear-resisting layer 124 of plastics. And, according to its characteristics and the states of use, the probing unit 12 may varies among a collimated beam probe, a diagonal beam probe, and an immersion fluid probe. When the plate steel on site is thinner, a double-crystal collimated-beam probe is used to prevent from overspreading the back echo wave of the thinner object caused by the broader initial pulse wave from a general probe. The double-crystal collimated-beam probe comprises two neighboring, one for transmitting waves and the other for sensing waves. Because the initial pulse wave of the double-crystal collimated-beam probe can be none or very small, the distinguishability of the back echo can be improved relatively.

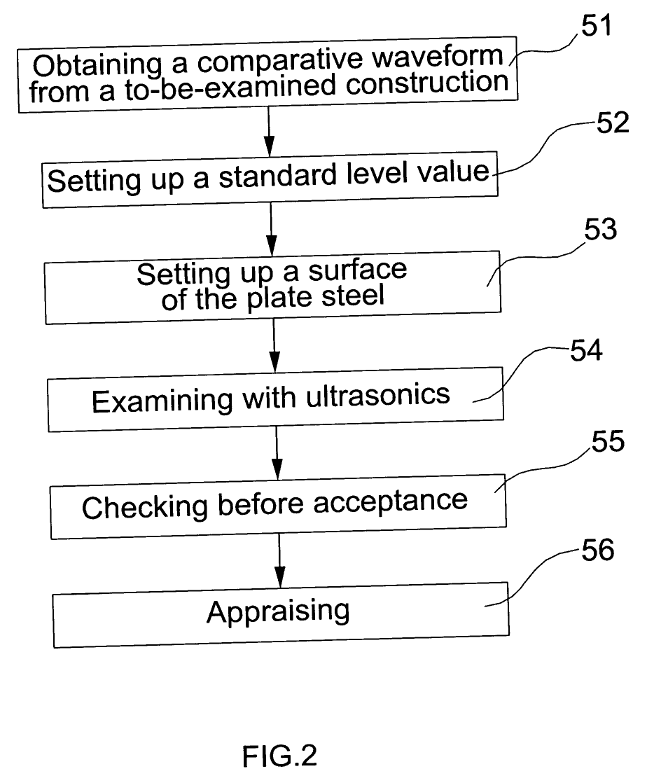

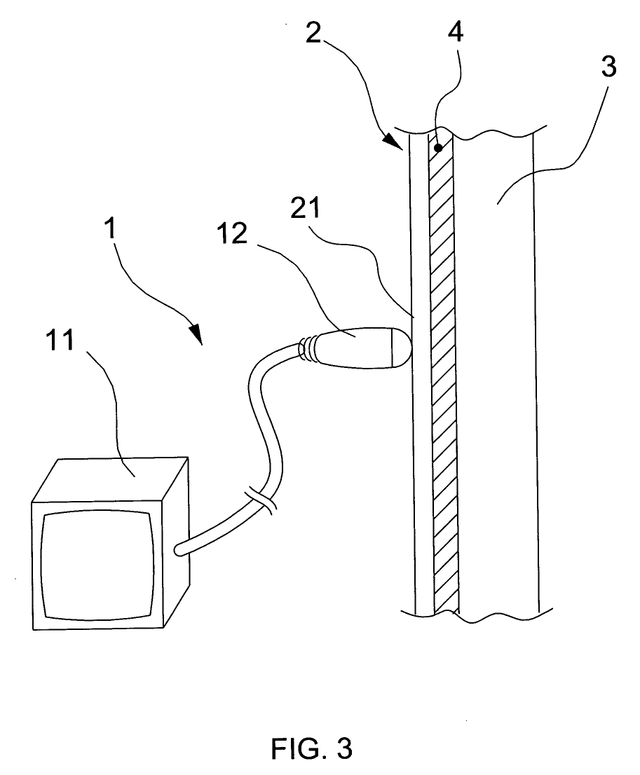

Please refer to FIG. 2 and FIG. 3, which are a flow chart of the method for examining a plate steel on a concrete, and a view of a state of use, according to the present invention. As shown in the figures, the present invention is a method for examining a plate steel on a concrete, comprising the following steps:
(a) Obtaining a comparative waveform from a to-be-examined construction 51
   A comparative waveform is obtained in advance from a same material as the plate steel 2 where the same material is fixed on the construction 3 with full coherence integrity of a joint interface 4 between the same material and the construction 3.
(b) Setting up a standard level value 52
   An ultrasonic detector 1 is obtained with the comparative waveform inputted in.
(c) Setting up a surface of the plate steel 53
   To-be-examined areas 21 are marked off on a surface of the plate steel 2; and, in each to-be-examined area, a benchmark is obtained for an examination.
(d) Examining with ultrasonics 54
   Signals are transmitted to the benchmark by the ultrasonic detector 1 to be refracted through and reflected by the plate steel 2, the joint interface 4 and the construction 3 so that a back echo waveform is obtained at the benchmark from a reflected signal to be received by the ultrasonic detector 1.
(e) Checking 55 and appraising 56
   And, by using the ultrasonic detector 1, the comparative waveform obtained in step (a) is compared with the back echo waveform obtained in step (d) to identify the coherence integrity of the joint interface 4 between the plate steel 2 and the construction 3 in the to-be-examined area 21.

Following the above steps, a novel method for examining a plate steel on a concrete is obtained.

The present invention utilizes an ultrasonic examination to identify the coherence integrity of a plate steel for reinforcing a construction. The examination is done by measuring a back echo waveform from the plate steel and recording the changes in the amplitude of vibration of the signals so that the cohering or the coming-off between the plate steel and the construction can be identified. So, the present invention is simple and effective on helping technicians with assuring from the quality of a reinforcement structure to the safety of the whole construction.

To sum up, the present invention is a method for examining a plate steel on a concrete, where, by using an ultrasonic detector, a comparative waveform obtained in advance is compared with a back echo waveform received so that a coherence integrity of a joint interface between the plate steel and the concrete can be identified.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method for examining a plate steel on a concrete, concerning coherence integrity of a joint interface between said plate steel and said concrete, comprising steps of:
(a) Obtaining a comparative waveform;
(b) Obtaining an ultrasonic detector with said comparative waveform inputted in;
(c) Marking off a to-be-examined area on a surface of said plate steel and, obtaining a benchmark in said to-be-examined area;
(d) Transmitting signals from said ultrasonic detector to said benchmark to be refracted through and reflected by said plate steel, said joint interface and said concrete to receive a back echo waveform at said benchmark by said ultrasonic detector; and
(e) By using said ultrasonic detector, comparing said comparative waveform obtained in step (a) with said back echo waveform obtained in step (d) to identify said coherence integrity of said joint interface between said plate steel and said concrete in said to-be-examined area.

2. The method according to claim 1, wherein said comparative waveform is obtained from a same material as said plate steel; and wherein said same material is fixed on said concrete with complete coherence integrity of a joint interface between said same material and said concrete.

3. The method according to claim 1, wherein a frequency of said signals from said ultrasonic detector is located between 1 MHz and 25 MHz.

4. The method according to claim 1, wherein said ultrasonic detector comprises an ultrasonic examining unit and a probing unit connected with said ultrasonic examining unit.
